(19) United States
(12) Patent Application Publication
(10) Pub. No.: US 2026/0281754 A1
(43) Pub. Date: Sep. 17, 2026

(54) WIRELESS MEASUREMENT DEVICE AND WIRELESS MEASUREMENT METHOD

(71) Applicant: ANRITSU CORPORATION, Kanagawa (JP)

(72) Inventor: Takaaki KAMISAWA, Kanagawa (JP)

(21) Appl. No.: 19/561,650

(22) Filed: Mar. 10, 2026

(30) Foreign Application Priority Data
Mar. 14, 2025 (JP) 2025-041504

(51) Int. Cl. H04W 24/06; H04B 17/15; H04W 24/10

(52) U.S. Cl. CPC H04W 24/06; H04B 17/15; H04W 24/10

(57) ABSTRACT

A wireless measurement device includes a setting unit that sets the number of samples, an input level range, and an attenuation change amount of a transmission signal as first measurement conditions, a cross correlation EVM calculation unit that calculates error vectors from the pieces of IQ data, performs a cross correlation calculation using the calculated error vectors, and averages results of the cross correlation calculation to calculate a cross correlation EVM, and a display unit that displays a graph showing the calculated cross correlation EVM and the input level, in which an appropriate input level is selected based on the cross correlation EVM and the input level.

### TECHNICAL FIELD

The present invention relates to a wireless measurement device and a wireless measurement method that receive a transmission signal from a device under test (DUT) and perform measurement.

### BACKGROUND ART

Recent developments in communication require an increase in signal bandwidth and an increase in modulation order. For example, in a next-generation communication standard of WLAN standard IEEE 802.11be, there is a demand for a signal bandwidth of 160 MHz to 320 MHz and a modulation method of 256 QAM to 1024 QAM and 4096 QAM, and EVM requirements are stricter as the modulation order increases.

Further, in 4096 QAM of the WLAN standard IEEE 802.11be, an EVM is set to -38 dB. In the above case, a sufficient margin is required for highly reliable measurement, and a residual EVM of -53 to -55 dB is expected as performance required for a signal source and a spectrum analyzer.

As a method of measuring such high-accuracy EVM, a method of calculating cross correlation EVM is a very effective method. In a cross correlation EVM algorithm, high-accuracy EVM measurement of the signal source is achieved by using a technique in which floor noise of a measuring instrument is received in two channels and EVM is calculated using two error vectors to cancel uncorrelated noise.

Patent Document 1 discloses a measurement system that splits a measurement signal from a DUT into two parts and calculates phase noise.

### Related art Document

### Patent Document

[Patent Document 1] JP-A-2019-158418

### DISCLOSURE OF THE INVENTION

### Problem that the Invention is to Solve

However, in a case where the measurement signal from the DUT is split into two parts as in Patent Document 1 and an actual EVM measurement is performed using two error vectors, there is a limitation on a measurement time and the number of samples. For this reason, a user needs to select an appropriate input level and the number of samples to perform the measurement.

The present invention has been made in view of the above problems, and a first object of the present invention is to provide a wireless measurement device and a wireless measurement method capable of selecting an appropriate input level, and a second object of the present invention is to provide a wireless measurement device and a wireless measurement method capable of obtaining a more preferable cross correlation EVM value.

### Means for solving the problem

In order to achieve the above object, a wireless measurement device according to claim 1 of the present invention including:

a setting unit 2 that sets the number of samples, an input level range, and an attenuation change amount of a transmission signal acquired from a signal generation device W to be measured, as a first measurement condition 11;

a distributor 3 that splits, into two parts, the transmission signal from the signal generation device;

a first signal analysis unit 4 that attenuates one transmission signal, which is subjected to the split into two parts by the distributor, in the input level range set by the setting unit, downconverts the attenuated signal, and then decodes the downconverted signal to output first IQ data;

a second signal analysis unit 5 that attenuates the other transmission signal, which is subjected to the split into two parts by the distributor, in the input level range set by the setting unit, downconverts the attenuated signal, and then decodes the downconverted signal to output second IQ data;

a cross correlation EVM calculation unit 6 that calculates error vectors from the first IQ data and the second IQ data, performs a cross correlation calculation using the calculated error vectors, and averages results of the cross correlation calculation to calculate a cross correlation EVM; and

a display unit 7 that displays a relationship between the cross correlation EVM, which is calculated by the cross correlation EVM calculation unit, and the input level,

in which an appropriate input level is selected based on the cross correlation EVM and the input level.

The wireless measurement device according to claim 2 of the present invention is the wireless measurement device according to claim 1,

in which the cross correlation EVM, which is calculated by the cross correlation EVM calculation unit 6, and the input level displayed on the display unit 7 are displayed in a graph.

The wireless measurement device according to claim 3 of the present invention is the wireless measurement device according to claim 2,

in which a user selects an appropriate input level based on the graph.

The wireless measurement device according to claim 4 of the present invention is the wireless measurement device according to claim 2,

in which the cross correlation EVM calculation unit 6 calculates a cross correlation EVM in a case where the setting unit 2 sets the input level, which is selected from the graph showing the cross correlation EVM and the input level, and a range of the number of samples, as a second measurement condition 12,

the display unit 7 displays a graph showing the cross correlation EVM, which is calculated by the cross correlation EVM calculation unit in a case where the second measurement condition is set, and the number of samples, and

a final EVM value is calculated from the graph showing the cross correlation EVM and the number of samples.

A wireless measurement method according to claim 5 of the present invention including:

a step of setting the number of samples, an input level range, and an attenuation change amount of a transmission signal acquired from a signal generation device W to be measured, as a first measurement condition 11;

a step of splitting, into two parts, the transmission signal from the signal generation device, by a distributor 3;

a step of attenuating one transmission signal, which is subjected to the split into two parts, in the set input level range, downconverting the attenuated signal, and then performing processing to output first IQ data;

a step of attenuating the other transmission signal, which is subjected to the split into two parts, in the set input level range, downconverting the attenuated signal, and then performing processing to output second IQ data;

a step of calculating error vectors from the first IQ data and the second IQ data, performing a cross correlation calculation using the calculated error vectors, and averaging results of the cross correlation calculation to calculate a cross correlation EVM;

a step of displaying a relationship between the calculated cross correlation EVM and the input level; and

a step of selecting an appropriate input level based on the cross correlation EVM and the input level.

The wireless measurement method according to claim 6 of the present invention is the wireless measurement method according to claim 5, the wireless measurement method further including:

a step of displaying the cross correlation EVM, which is calculated in the step of calculating the cross correlation EVM, and the input level in a graph, and selecting an appropriate input level based on the graph.

The wireless measurement method according to claim 7 of the present invention is the wireless measurement method according to claim 6, the wireless measurement method further including:

a step of calculating a cross correlation EVM in a case where the input level, which is selected from the graph showing the cross correlation EVM and the input level, and a range of the number of samples are set, as a second measurement condition 12;

a step of displaying a graph showing the cross correlation EVM, which is calculated in a case where the second measurement condition is set, and the number of samples; and

a step of calculating a final EVM value from the graph showing the cross correlation EVM and the number of samples.

### Advantage of the Invention

According to the present invention, with the check of the graph showing the relationship between the cross correlation EVM and the input level, an appropriate input level can be selected. With the check of the graph showing the relationship between the cross correlation EVM and the number of samples based on the selected appropriate input level and the range of the number of samples, a more preferable EVM value can be obtained.

### BRIEF DESCRIPTION OF THE DRAWINGS

FIG. 1 is a block diagram showing a schematic configuration of a wireless measurement device according to the present invention.

FIG. 2 is a flowchart showing a schematic operation of a measurement method using the wireless measurement device according to the present invention.

FIG. 3 is a diagram showing a display example of a first measurement condition and a first measurement result in the wireless measurement device according to the present invention.

FIG. 4 is a diagram showing a display example of a second measurement condition and a second measurement result in the wireless measurement device according to the present invention.

### BEST MODE FOR CARRYING OUT THE INVENTION

Hereinafter, embodiments of the present invention will be described in detail with reference to accompanying drawings.

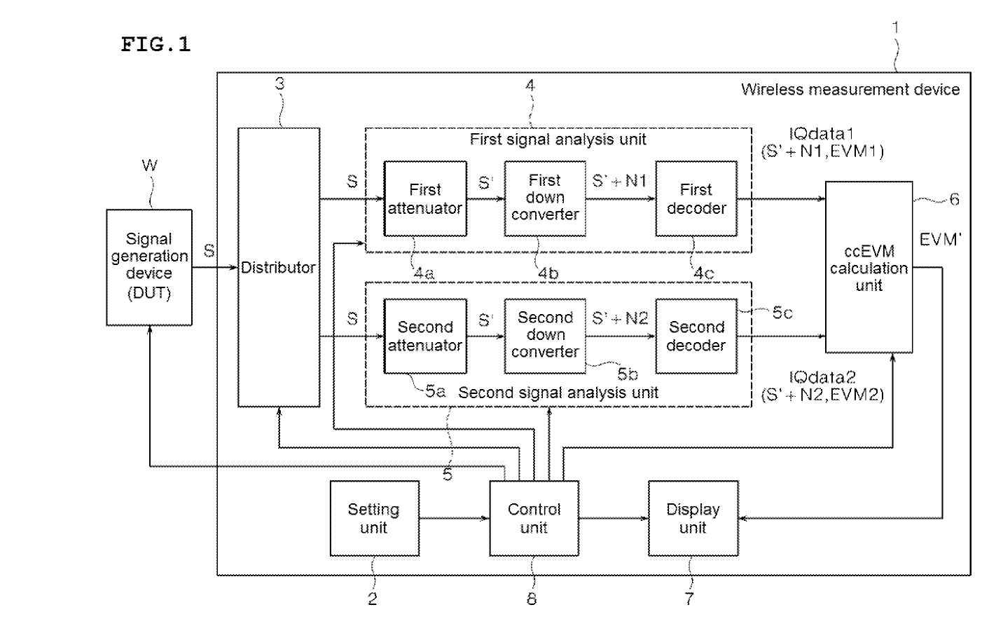

As shown in FIG. 1, a wireless measurement device 1 is connected to a signal generation device (device under test: DUT) W that generates a transmission signal (measurement signal) S of a radio frequency (RF) to be measured and receives the transmission signal S from the signal generation device W to perform measurement, and is schematically configured to include a setting unit 2, a distributor 3, a first signal analysis unit 4, a second signal analysis unit 5, a cross correlation EVM calculation unit 6, a display unit 7, and a control unit 8.

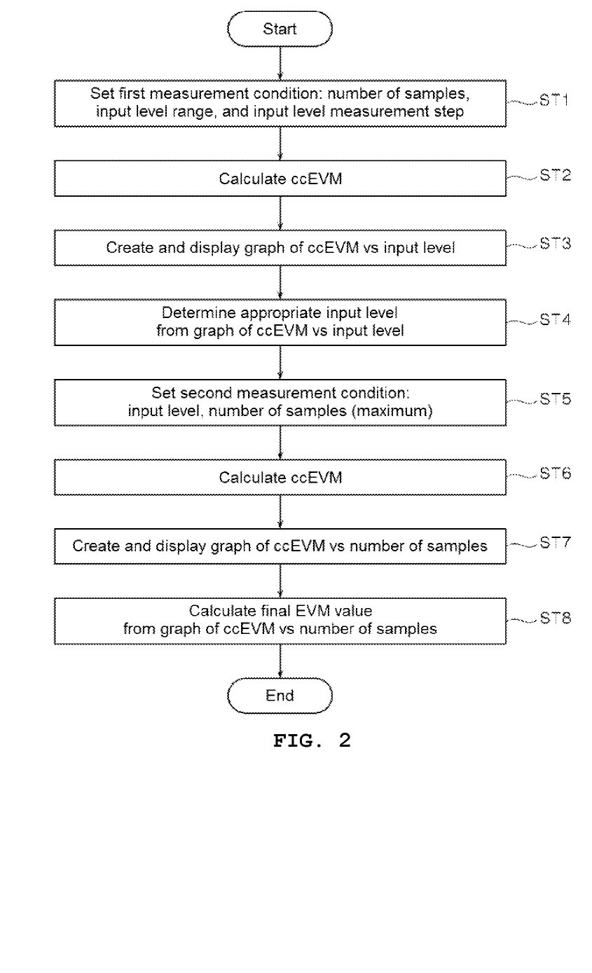

In a case where measurement in accordance with a procedure of a flowchart of FIG. 2 described below is performed, the setting unit 2 sets, as a first measurement condition, the number of samples of the transmission signal S acquired from the signal generation device W, an input level range (range of attenuation amount in first attenuator 4a and second attenuator 5a described below), and an input level measurement step (an attenuation change amount of the input level in the first attenuator 4a and the second attenuator 5a described below).

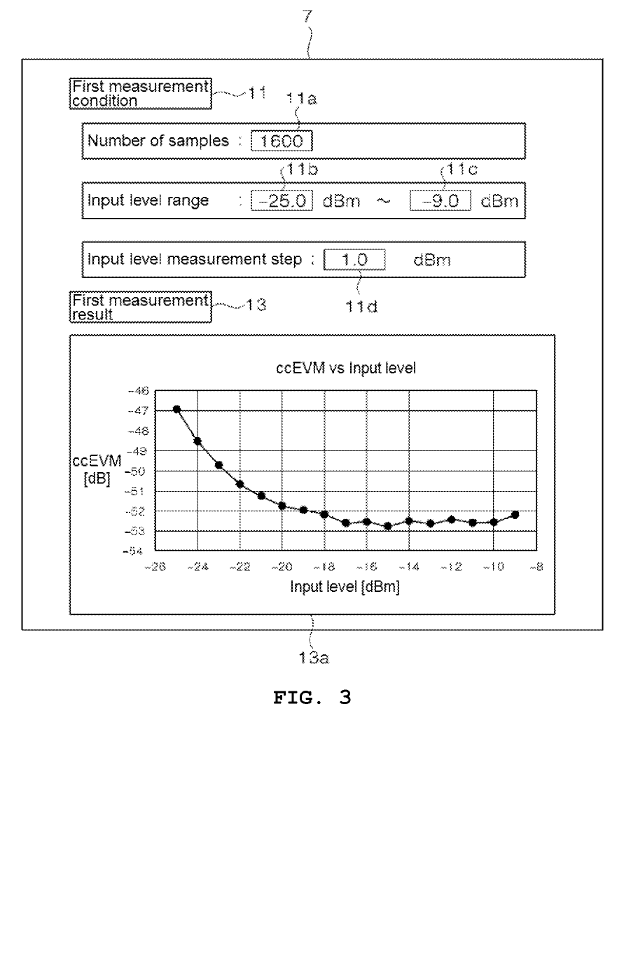

As a specific example of a first measurement condition 11, for example, as shown in FIG. 3, “1600” is input and set in an input box 11a for the number of samples, “-25.0" (dBm) is input and set in an input box 11b for a lower limit value of the input level range, “-9.0" (dBm) is input and set in an input box 11c for an upper limit value of the input level range, and “1.0" (dBm) is input and set in an input box 11d for the input level measurement step.

In a case where the measurement in accordance with the procedure of the flowchart of FIG. 2 described below is performed, the setting unit 2 sets, as a second measurement condition after an appropriate input level is selected, the selected appropriate input level and the number of samples (maximum) of the transmission signal S acquired from the signal generation device W.

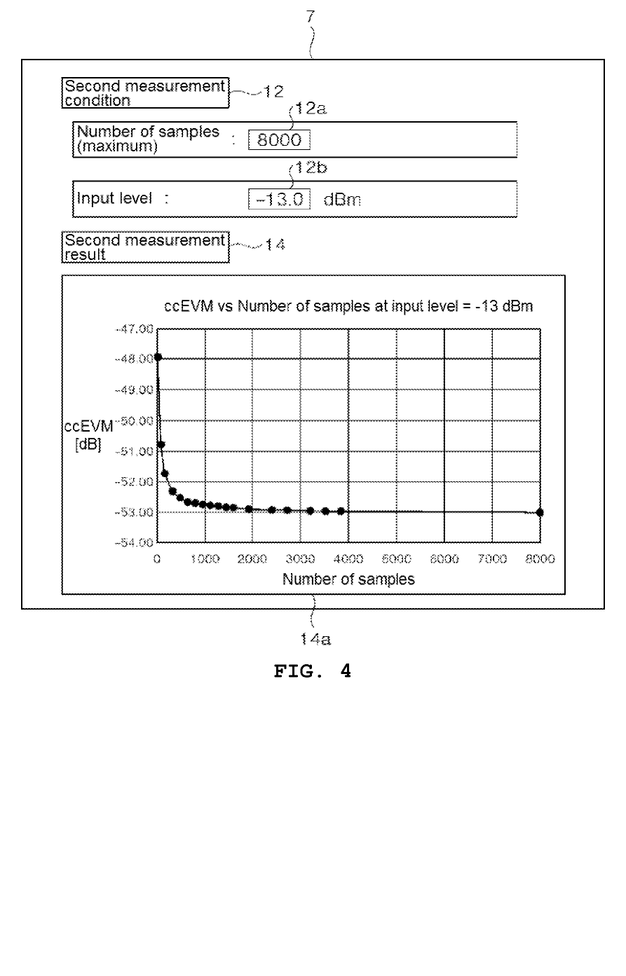

As a specific example of a second measurement condition 12, for example, as shown in FIG. 4, “8000” is input and set in an input box 12a for the number of samples (maximum), and “-13.0” (dBm) is input and set in an input box 12b for the input level.

Under the control of the control unit 8, the distributor 3 splits, into two parts, the transmission signal (measurement signal) S generated by the signal generation device W, and inputs the split signals to the first signal analysis unit 4 and the second signal analysis unit 5, respectively.

The first signal analysis unit 4 performs signal analysis of one transmission signal S, which is input from the signal generation device W by being subjected to the split into two parts via the distributor 3, under the control of the control unit 8, and includes a first attenuator 4a, a first down converter 4b, and a first decoder 4c.

The first attenuator 4a attenuates one transmission signal S, which is input from the distributor 3 by being subjected to the split into two parts, by an attenuation amount set by the setting unit 2, and inputs an attenuated signal S' to the first down converter 4b.

The first down converter 4b downconverts the signal S' attenuated by the first attenuator 4a into a signal of an intermediate frequency (IF), and inputs a downconverted signal S'+N1 to the first decoder 4c. N1 is floor noise of the first signal analysis unit 4.

The first decoder 4c performs decoding processing on the signal S’+N1 including the floor noise N1, which is downconverted into the signal of the intermediate frequency by the first down converter 4b, and inputs IQ data (constellation data): IQdata1 (S’+N1, EVM1) to the cross correlation EVM calculation unit 6.

The second signal analysis unit 5 performs signal analysis of the other transmission signal S, which is input from the signal generation device W by being subjected to the split into two parts via the distributor 3, under the control of the control unit 8, and includes a second attenuator 5a, a second down converter 5b, and a second decoder 5c, similarly to the first signal analysis unit 4.

The second attenuator 5a attenuates the other transmission signal S, which is input from the distributor 3 by being subjected to the split into two parts, by an attenuation amount set by the setting unit 2, and inputs an attenuated signal S' to the second down converter 5b.

The second down converter 5b downconverts the signal S' attenuated by the second attenuator 5a into a signal of an intermediate frequency (IF), and inputs a downconverted signal S'+N2 to the second decoder 5c. N2 is floor noise of the second signal analysis unit 5.

The second decoder 5c performs decoding processing on the signal S’+N2 including the floor noise N2, which is downconverted into the signal of the intermediate frequency by the second down converter 5b, and inputs IQ data (constellation data): IQdata2 (S’+N2, EVM2) to the cross correlation EVM calculation unit 6.

Under the control of the control unit 8, the cross correlation EVM calculation unit 6 calculates error vectors from the IQ data of the first signal analysis unit 4 and the IQ data of the second signal analysis unit 5, performs a well-known cross correlation EVM calculation using the error vectors of the first signal analysis unit 4 and the second signal analysis unit 5, and performs averaging processing on results of the cross correlation EVM calculation to calculate the cross correlation EVM (EVM’).

Each transmission signal S, which is input to the first signal analysis unit 4 and the second signal analysis unit 5, is decoded, and then an IQ vector is output as a constellation. The error vector is obtained by subtracting a reference signal (ideal signal) from the IQ vector.

The display unit 7 is configured of, for example, a liquid crystal display (LCD) or an organic EL display (OLED), and displays, under the control of the control unit 8, the calculation result by the cross correlation EVM calculation unit 6, the measurement conditions (first measurement condition 11 and second measurement condition 12) and the measurement result (first measurement result 13 and second measurement result 14 described below) in a display format of FIGS. 3 and 4.

The control unit 8 is configured of, for example, a central processing unit (CPU), a read only memory (ROM), a random access memory (RAM), and the like, and integrally controls each unit (the signal generation device W, the setting unit 2, the distributor 3, the first signal analysis unit 4, the second signal analysis unit 5, the cross correlation EVM calculation unit 6, and the display unit 7) in order to perform the measurement in accordance with the procedure of the flowchart of FIG. 2 described below.

With the wireless measurement device 1, the EVM result that is better by 6 dB or more can be obtained from the EVM (EVM1 and EVM2) at each end of the signal analysis units 4 and 5. Further, in a case where the attenuation amounts of the attenuators 4a and 5a of the signal analysis units 4 and 5 are simply increased and the input level of the transmission signal S is decreased, an uncorrelated distortion characteristic of each of the signal analysis units 4 and 5 is improved, and the calculation result (EVM’) of the cross correlation EVM can be improved.

However, since the S/N relative to the floor noise (N1, N2) of each of the signal analysis units 4 and 5 deteriorates, the EVM (EVM1 and EVM2) calculated by each of the signal analysis units 4 and 5 also deteriorates.

Further, in a case where a value of the EVM (EVM1, EVM2) of each of the signal analysis units 4 and 5 is high (bad), a large number of samples are required for a cross correlation average value obtained by the average of the cross correlation calculation in the cross correlation EVM calculation unit 6 to converge, and thus a calculation amount increases and a calculation time also increases. In addition, in actual measurement, there is a limitation on a measurement time and the number of samples. For this reason, the appropriate input level and the number of samples need to be selected to perform the measurement.

In the present embodiment, in order to solve the above problem to select the appropriate input level, the measurement is performed according to the procedure of the flowchart of FIG. 2, under the control of the control unit 8 based on the setting of the first measurement condition 11 and the second measurement condition 12 by the setting unit 2 described above. Hereinafter, a measurement method of the present embodiment will be described with reference to the flowchart of FIG. 2.

First, the setting unit 2 sets, as the first measurement condition 11, the number of samples, the input level range, and the input level measurement step of the transmission signal S of the signal generation device (DUT) (ST1). For example, the number of samples: 1600, the input level range: -25 dBm to -9.0 dBm, and the input level measurement step: 1.0 dBm are input and set, as the first measurement condition 11, as shown in FIG. 3.

Next, the measurement is performed under the first measurement condition 11 set by the setting unit 2, and the cross correlation EVM is calculated (ST2).

A graph of cross correlation EVM (vertical axis) vs input level (horizontal axis) is created based on the calculated cross correlation EVM and the input level range of the first measurement condition 11, and the created graph of cross correlation EVM vs input level is displayed on the display unit 7 as the first measurement result 13 (ST3). Specifically, in a case where the number of samples: 1600, the input level range: -25 dBm to -9.0 dBm, and the input level measurement step: 1.0 dBm are set as the first measurement condition 11, a graph 13a of cross correlation EVM vs input level shown in FIG. 3 is displayed on the display unit 7 as the first measurement result 13.

Next, the graph of cross correlation EVM vs input level is checked, and an appropriate input level is determined (ST4).

Subsequently, in order to determine the input level of a final test in which the number of samples is increased and to perform measurement, the setting unit 2 sets the appropriate input level, which is determined from the graph of cross correlation EVM vs input level (for example, graph 13a of cross correlation EVM vs input level of the first measurement result 13 in FIG. 3), and the number of samples (maximum), as the second measurement condition 12 (ST5). For example, the number of samples (maximum): 8000 and the input level: -13.0 dBm are input and set, as the second measurement condition 12, as shown in FIG. 4.

Next, the measurement is performed under the second measurement condition 12 set by the setting unit 2, and the cross correlation EVM is calculated (ST6).

A graph of cross correlation EVM (vertical axis) vs number of samples (horizontal axis) is created based on the calculated cross correlation EVM and the number of samples of the second measurement condition 12, and the created graph of cross correlation EVM vs number of samples is displayed on the display unit 7 as the second measurement result 14 (ST7). Specifically, in a case where the number of samples (maximum): 8000 and the input level: -13.0 dBm are set as the second measurement condition 12, a graph 14a of cross correlation EVM vs number of samples shown in FIG. 4 is displayed on the display unit 7 as the second measurement result 14.

Next, check is made whether or not the number of samples is sufficient (whether or not the cross correlation EVM value has converged) from the graph of cross correlation EVM vs number of samples, and a final EVM value is calculated (ST8).

Incidentally, in the above embodiment, the first signal analysis unit 4 and the second signal analysis unit 5 are shown in FIG. 1 by a dotted line as separate blocks, but can be mounted in the same housing (module) or separate housings (modules).

As described above, according to the present embodiment, with the check of the graph showing the relationship between the cross correlation EVM and the input level, which is obtained as the first measurement result 13 in a case where the number of samples, the input level range, and the input level measurement step of the transmission signal S acquired from the signal generation device W to be measured are set as the first measurement condition 11, the appropriate input level can be selected.

With the check of the graph showing the relationship between the cross correlation EVM and the number of samples, which is obtained as the second measurement result 14 in a case where the appropriate input level and the range of the number of samples selected by the check of the graph showing the relationship between the cross correlation EVM and the input level are set as the second measurement condition 12, a more preferable EVM value can be obtained.

The best embodiments of the wireless measurement device and the wireless measurement method according to the present invention have been described above, but the present invention is not limited to the description and the drawings according to the embodiments. That is, it goes without saying that other modes, embodiments, and operational techniques implemented by those skilled in the art based on this mode are all included within the scope of the present invention.

### DESCRIPTION OF REFERENCE NUMERALS AND SIGNS

1: wireless measurement device

2: setting unit

3: distributor

4: first signal analysis unit

4a: first attenuator

4b: first down converter

4c: first decoder

5: second signal analysis unit

5a: second attenuator

5b: second down converter

5c: second decoder

6: cross correlation EVM calculation unit

7: display unit

8: control unit

11: first measurement condition

11a: input box for number of samples

11b: input box for lower limit value of input level range

11c: input box for upper limit value of input level range

11d: input box for input level measurement step

12: second measurement condition

12a: input box for number of samples (maximum)

12b: input box for input level

13: first measurement result

13a: graph of cross correlation EVM vs input level

14: second measurement result

14a: graph of cross correlation EVM vs number of samples

W: signal generation device (DUT)

What is claimed is:

1. A wireless measurement device comprising:
a setting unit that sets the number of samples, an input level range, and an attenuation change amount of a transmission signal acquired from a signal generation device to be measured, as a first measurement condition;
a distributor that splits, into two parts, the transmission signal from the signal generation device;
a first signal analysis unit that attenuates one transmission signal, which is subjected to the split into two parts by the distributor, in the input level range set by the setting unit, downconverts the attenuated signal, and then decodes the downconverted signal to output first IQ data;
a second signal analysis unit that attenuates the other transmission signal, which is subjected to the split into two parts by the distributor, in the input level range set by the setting unit, downconverts the attenuated signal, and then decodes the downconverted signal to output second IQ data;
a cross correlation EVM calculation unit that calculates error vectors from the first IQ data and the second IQ data, performs a cross correlation calculation using the calculated error vectors, and averages results of the cross correlation calculation to calculate a cross correlation EVM; and
a display unit that displays the cross correlation EVM, which is calculated by the cross correlation EVM calculation unit, and the input level,
wherein an appropriate input level is selected based on the cross correlation EVM and the input level.

2. The wireless measurement device according to claim 1,
wherein the cross correlation EVM, which is calculated by the cross correlation EVM calculation unit, and the input level displayed on the display unit are displayed in a graph.

3. The wireless measurement device according to claim 2,
wherein a user selects an appropriate input level based on the graph.

4. The wireless measurement device according to claim 2,
wherein the cross correlation EVM calculation unit calculates a cross correlation EVM in a case where the setting unit sets the input level, which is selected from the graph showing the cross correlation EVM and the input level, and a range of the number of samples, as a second measurement condition,
the display unit displays a graph showing the cross correlation EVM, which is calculated by the cross correlation EVM calculation unit in a case where the second measurement condition is set, and the number of samples, and
a final EVM value is calculated from the graph showing the cross correlation EVM and the number of samples.

5. A wireless measurement method comprising:
a step of setting the number of samples, an input level range, and an attenuation change amount of a transmission signal acquired from a signal generation device to be measured, as a first measurement condition;
a step of splitting, into two parts, the transmission signal from the signal generation device, by a distributor;
a step of attenuating one transmission signal, which is subjected to the split into two parts, in the set input level range, downconverting the attenuated signal, and then performing processing to output first IQ data;
a step of attenuating the other transmission signal, which is subjected to the split into two parts, in the set input level range, downconverting the attenuated signal, and then performing processing to output second IQ data;
a step of calculating error vectors from the first IQ data and the second IQ data, performing a cross correlation calculation using the calculated error vectors, and averaging results of the cross correlation calculation to calculate a cross correlation EVM;
a step of displaying the calculated cross correlation EVM and the input level; and
a step of selecting an appropriate input level based on the cross correlation EVM and the input level.

6. The wireless measurement device according to claim 5, further comprising:
a step of displaying the cross correlation EVM, which is calculated in the step of calculating the cross correlation EVM, and the input level in a graph, and selecting an appropriate input level based on the graph.

7. The wireless measurement method according to claim 6, further comprising:
a step of calculating a cross correlation EVM in a case where the input level, which is selected from the graph showing the cross correlation EVM and the input level, and a range of the number of samples are set, as a second measurement condition;
a step of displaying a graph showing the cross correlation EVM, which is calculated in a case where the second measurement condition is set, and the number of samples; and
a step of calculating a final EVM value from the graph showing the cross correlation EVM and the number of samples.
